(19) United States
(12) Patent Application Publication
(10) Pub. No.: US 2025/0237776 A1
(43) Pub. Date: Jul. 24, 2025

(54) SYSTEM AND METHOD FOR MULTIDIMENSIONAL DECONVOLUTION

(71) Applicant: Schlumberger Technology Corporation, Sugar Land, TX (US)

(72) Inventors: Daniele Boiero, Houston, TX (US); Claudio Bagaini, Gatwick (GB); Rajiv Kumar, Gatwick (GB); Massimiliano Vassallo, Gatwick (GB)

(21) Appl. No.: 18/703,642

(22) PCT Filed: Jan. 13, 2022
(86) PCT No.: PCT/US2022/070165

§ 371 Date: Apr. 22, 2024

(51) Int. Cl. G01V 1/32; G01V 1/30

(52) U.S. Cl. CPC G01V 1/32; G01V 1/306; G01V 2210/675

(57) ABSTRACT

Systems and methods are provided for performing multidimensional deconvolution. An exemplary method includes: receiving, using at least one processor, a first data associated with waves propagating in a seismic structure; selecting, using the at least one processor, a first transform to be applied to the first data; determining, using the least one processor, whether the first transform is a sparsity or rank revealing transform to optimize sparsity or rank minimization; if the first transform is the sparsity or rank transform, applying, using the at least one processor, the first transform to the first data to produce a second data; calculating, using the at least one processor and the second data, at least one Green's function associated with the first data; and predicting, using the at least one processor and the at least one Green's function, material properties throughout the seismic structure to facilitate exploratory and/or production operations.

### BACKGROUND

The current approaches used to perform multidimensional deconvolution (MDD) in the area of seismic data acquisition are ill-conditioned, for example, the point-spread function matrix contains small singular values. This is because the recorded seismic wavefields exhibit practical challenges introduced by the finite bandwidth/aperture of the seismic acquisition along with the source-receiver array directivity. To overcome the numerical instability, the least-squares system used in multidimensional deconvolution can be solved using a regularization scheme, which stabilizes the MDD but comes at a price of undesired loss in the resolution of the inverted Green's function.

To further stabilize the multidimensional deconvolution (MDD), the least-squares system is regularized by exploiting the sparsity of the seismic wavefields in the curvelet-domain. The idea is to exploit the multiscale, multidirectional, and parabolic scaling properties of the curvelets, which makes seismic data sparse/compressible in this domain while preserving the resolution of the complex seismic wavefields. Using the complex synthetic geological model, it showed the advantages of the curvelet-domain based regularization over the damped least-squares solution for the MDD. However, the curvelet-domain based sparsity promotion solvers come with very high computational cost and memory requirements due to transform-domain redundancy, thus making it an impractical solution for large-scale seismic data acquisition.

### BRIEF DESCRIPTION OF THE DRAWINGS

For a better understanding of the embodiments disclosed herein, reference should be made to the Detailed Description below, in conjunction with the following drawings in which like reference numerals refer to corresponding parts throughout the figures.

FIG. 1A illustrates a simplified schematic view of a survey operation performed by a survey tool at an oil field, in accordance with some embodiments.

FIG. 1B illustrates a simplified schematic view of a drilling operation performed by drilling tools, in accordance with some embodiments.

FIG. 1C illustrates a simplified schematic view of a production operation performed by a production tool, in accordance with some embodiments.

FIG. 2 illustrates a schematic view, partially in cross section, of an oilfield, in accordance with some embodiments.

FIG. 3 illustrates a schematic diagram of an acquisition geometry used in seismic interferometry for multidimensional deconvolution (MDD), in accordance with some embodiments.

FIG. 4A illustrates a simulation result of velocity used in a density model, in accordance with some embodiments.

FIG. 4B illustrates a simulation result of a density model used for generating the pressure and vertical particle velocity component data, in accordance with some embodiments.

FIG. 5A illustrates down-going wavefields generated from the pressure and velocity component, in accordance with some embodiments.

FIG. 5B illustrates up-going wavefields generated from the pressure and velocity component, in accordance with some embodiments.

FIG. 6A illustrates an inverted Green's function using the damped least-squares solution, in accordance with some embodiments.

FIG. 6B illustrates an inverted Green's function using the curvelet-based sparsity-promotion, in accordance with some embodiments.

FIG. 7A illustrates a matricized up-going wavefield for Nₛₓ×N_{sy}, in accordance with some embodiments.

FIG. 7B illustrates a detailed view of the matricized up-going wavefield of FIG. 7A, in accordance with some embodiments.

FIG. 7C illustrates a matricized up-going wavefield for Nₛₓ×Nᵣₓ, in accordance with some embodiments.

FIG. 7D illustrates a detailed view of the matricized up-going wavefield of FIG. 7C, in accordance with some embodiments.

FIG. 7E illustrates the singular value decay of the up-going wavefield, in accordance with some embodiments.

FIG. 8A illustrates an inverted Green's function using the factorization-based rank-minimization framework extracted at a common virtual source, in accordance with some embodiments.

FIG. 8B illustrates an inverted Green's function using the proposed factorization-based rank-minimization framework extracted at a common receiver location, in accordance with some embodiments.

FIG. 9 illustrates a workflow of a method for performing multidimensional deconvolution, in accordance with some embodiments.

FIG. 10 illustrates a workflow of another method for performing multidimensional deconvolution, in accordance with some embodiments.

FIG. 11 illustrates an example of a computing system for carrying out some of the methods of the present disclosure, in accordance with some embodiments.

### BRIEF SUMMARY

According to one aspect of the subject matter described in this disclosure, a method is provided. The method includes the following: receiving, using at least one processor, a first data associated with waves propagating in a seismic structure; selecting, using the at least one processor, a first transform to be applied to the first data; determining, using the least one processor, whether the first transform is a sparsity or rank revealing transform to optimize sparsity or rank minimization; if the first transform is the rank revealing transform, applying, using the at least one processor, the first transform to the first data to produce a second data; calculating, using the at least one processor and the second data, at least one Green's function associated with the first data; and predicting, using the at least one processor and the at least one Green's function, material properties throughout the seismic structure to facilitate exploratory and/or production operations.

According to another aspect of the subject matter described in this disclosure, a method is provided. The method includes the following: receiving, using at least one processor, a first data associated with waves propagating in a seismic structure; analyzing, using the at least one processor, the first data to determine its corresponding dimensional information; selecting, using the at least one processor and the dimensional information, a first transform to be applied to the first data, wherein the first transform comprises a sparsity or rank revealing transform to optimize sparsity or rank minimization in accordance with the dimensional information of the first data; applying, using the at least one processor, the first transform to the first data to produce a second data; and calculating, using the at least one processor and the second data, at least one Green's function associated with the first data; and predicting, using the at least one processor and the at least one Green's function, material properties throughout the seismic structure to facilitate exploratory and/or production operations.

According to another aspect of the subject matter described in this disclosure, a system for performing multidimensional deconvolution is provided. The system includes one or more computing device processors. One or more computing device memories are coupled to the one or more computing device processors. The one or more computing device memories store instructions executed by the one or more computing device processors, wherein the instructions are configured to: receive a first data associated with waves propagating in a seismic structure; select a first transform to be applied to the first data; determine whether the first transform is a rank revealing transform utilizing rank minimization; if the first transform is a rank revealing transform, apply the first transform to the first data to produce a second data; estimate, using the second data, at least one Green's function associated with the first data; and predict, using the at least one Green's function, hydrocarbon content throughout the seismic structure to facilitate exploratory and/or production operations.

Additional features and advantages of the present disclosure are described in, and will be apparent from, the detailed description of this disclosure.

### DETAILED DESCRIPTION

Reference will now be made in detail to embodiments, examples of which are illustrated in the accompanying figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the present disclosure. The first object or step, and the second object or step, are both objects or steps, respectively, but they are not to be considered the same object or step.

The terminology used in the detailed description herein is for the purpose of describing particular embodiments and is not intended to be limiting of the present disclosure. As used in the detailed description and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., each of a plurality of objects, etc., the methods and techniques disclosed herein may also be performed on fewer than all of a given thing, e.g., performed on one or more components and/or performed on one or more objects. Accordingly, in instances in the disclosure where an absolute is used, the disclosure may also be interpreted to be referring to a subset.

The present disclosure describes a system and method for performing multidimensional deconvolution (MDD) using a computationally tractable factorization-based rank-minimization algorithm to mitigate the computational and memory bottleneck of the curvelet-based solver. The proposed algorithm is suitable for large-scale seismic data, since it avoids singular-value decompositions and uses a low-rank based factorized formulation instead. Moreover, the quality of the inversion using rank-minimization based solvers matches the curvelet-domain based sparsity solvers for the problems of data interpolation and source separation.

Moreover, disclosure describes performing the multidimensional deconvolution (MDD) on a carefully selected simple but geologically complex synthetic model, where the factorization-based rank-minimization framework is demonstrated to be computationally feasible, both in terms of speed and memory usage, for large-scale seismic data volumes while performing the multidimensional deconvolution.

Although, the rank-minimization-based methods can overcome the computational and memory bottleneck of multidimensional deconvolution, instability in rank-minimization MDD is observed at higher frequencies. This may be due to the coarser sampling of the data, high-rank nature of the seismic wavefields at higher-frequencies and working with monochromatic data independently and in parallel. Correlations between frequencies are exploited while performing MDD.

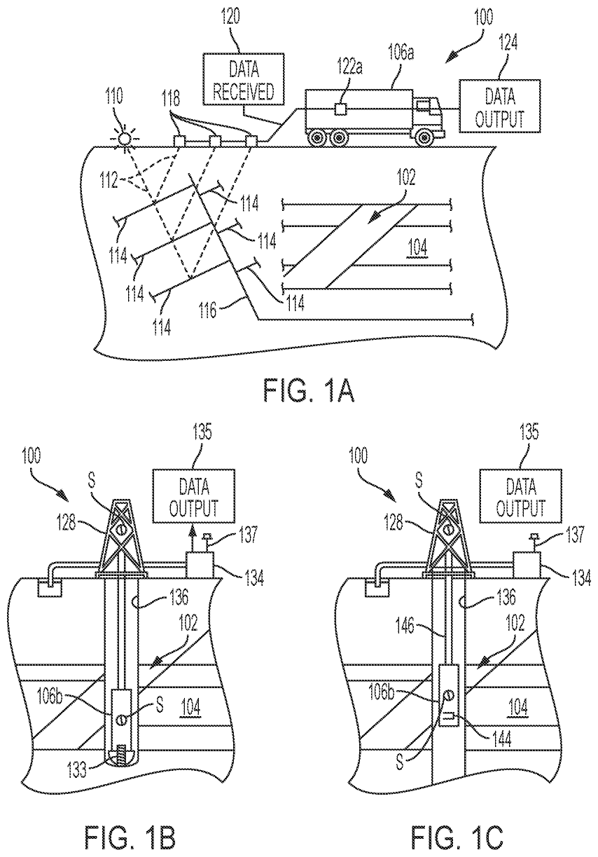

FIGS. 1A-1C illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106a, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122a of the seismic truck 106a, and responsive to the input data, computer 122a generates seismic data output 124. This seismic data output may be stored, transmitted or further processed as desired, for example, by data reduction.

FIG. 1B illustrates a drilling operation being performed by drilling tools 106b suspended by rig 128 and advanced into subterranean formations 102 to form wellbore 136. The drilling tools are advanced into subterranean formations 102 to reach reservoir 104. Each well may target one or more reservoirs. The drilling tools may be adapted for measuring downhole properties using logging while drilling tools. The logging while drilling tools may also be adapted for taking core sample 133 as shown.

The drilling tool 106b may include downhole sensor S adapted to perform logging while drilling (LWD) data collection. The sensor S may be any type of sensor.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

In some embodiments, sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. In some embodiments, sensors (S) may also be positioned in one or more locations in the wellbore 136.

Drilling tools 106b may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is configured to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

The data gathered by sensors (S) may be collected by surface unit 134 and/or other data collection sources for analysis or other processing. An example of the further processing is the generation of a grid for use in the computation of a juxtaposition diagram as discussed below. The data collected by sensors (S) may be used alone or in combination with other data. The data may be collected in one or more databases and/or transmitted on or offsite. The data may be historical data, real time data, or combinations thereof. The real time data may be used in real time (considered as substantially instantaneous), or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller.

FIG. 1C illustrates a production operation being performed by production tool 106c deployed by rig 128 having a Christmas tree valve arrangement into completed wellbore 136 for drawing fluid from the downhole reservoirs into rig 128. The fluid flows from reservoir 104 through perforations in the casing (not shown) and into production tool 106c in wellbore 136 and to rig 128 via gathering network 146.

In some embodiments, sensors (S), such as gauges, may be positioned about oilfield 100 to collect data relating to various field operations as described previously. As shown, the sensors (S) may be positioned in production tool 106c or rig 128.

While FIGS. 1A-1C illustrate tools used to measure properties of an oilfield, it will be appreciated that various measurement tools capable of sensing parameters, such as seismic two-way travel time, density, resistivity, production rate, etc., of the subterranean formation and/or its geological formations may be used. As an example, wireline tools may be used to obtain measurement information related to casing attributes. The wireline tool may include a sonic or ultrasonic transducer to provide measurements on casing geometry. The casing geometry information may also be provided by finger caliper sensors that may be included on the wireline tool. Various sensors may be located at various positions along the wellbore and/or the monitoring tools to collect and/or monitor the desired data. Other sources of data may also be provided from offsite locations.

The field configurations of FIGS. 1A-1C are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites. An example of processing of data collected by the sensors is the generation of a grid for use in the computation of a juxtaposition diagram as discussed below.

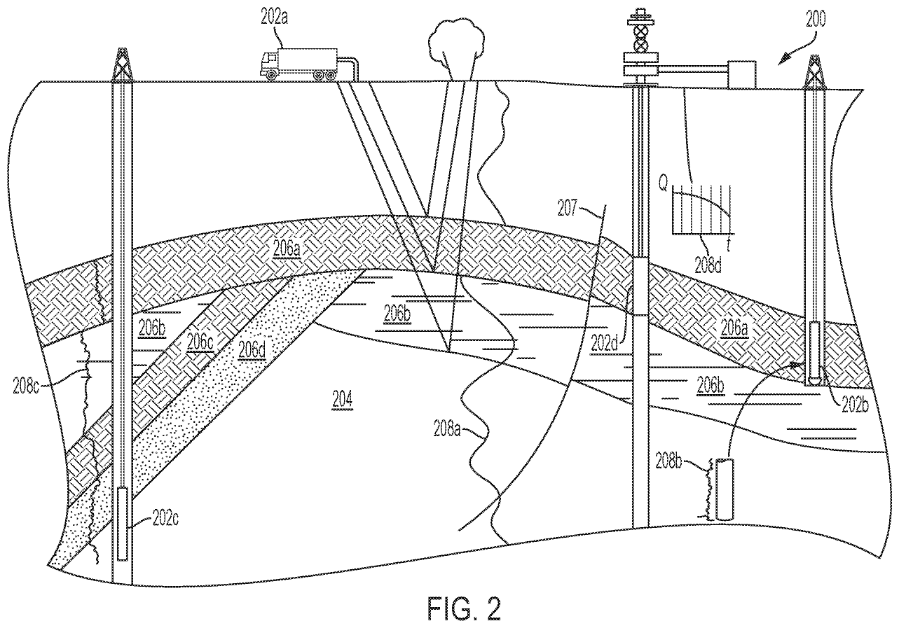

FIG. 2 illustrates a schematic view, partially in cross section of oilfield 200 having data acquisition tools 202a, 202b, 202c and 202d positioned at various locations along oilfield 200 for collecting data of subterranean formation 204 in accordance with implementations of various technologies and techniques described herein. Data acquisition tools 202a-202d may be the same as data acquisition tools 106a-106d of FIGS. 1A-1C, respectively, or others not depicted. As shown, data acquisition tools 202a-202d generate data plots or measurements 208a-208d, respectively. These data plots are depicted along oilfield 200 to demonstrate the data generated by the various operations.

Data plots 208a-208c are examples of static data plots that may be generated by data acquisition tools 202a-202c, respectively; however, it should be understood that data plots 208a-208c may also be data plots that are updated in real time (considered as substantially instantaneous). These measurements may be analyzed to better define the properties of the formation(s) and/or determine the accuracy of the measurements and/or for checking for errors. The plots of each of the respective measurements may be aligned and scaled for comparison and verification of the properties.

Static data plot 208a is a seismic two-way response over a period of time. Static plot 208b is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208c is a logging trace that provides a resistivity or other measurement of the formation at various depths.

A production decline curve or graph 208d is a dynamic data plot of the fluid flow rate over time. The production decline curve provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes information aspects over time.

The subterranean structure 204 has a plurality of geological formations 206a-206d. As shown, this structure has several formations or layers, including a shale layer 206a, a carbonate layer 206b, a shale layer 206c and a sand layer 206d. A fault 207 extends through the shale layer 206a and the carbonate layer 206b. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, for example below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurements may be taken at one or more locations across one or more fields or other locations for comparison and/or analysis.

The data collected from various sources, such as the data acquisition tools of FIG. 2, may then be processed and/or evaluated to form reservoir models for assessing a drill site. The exemplary collected data described herein may be use as inputs for the methods described hereafter.

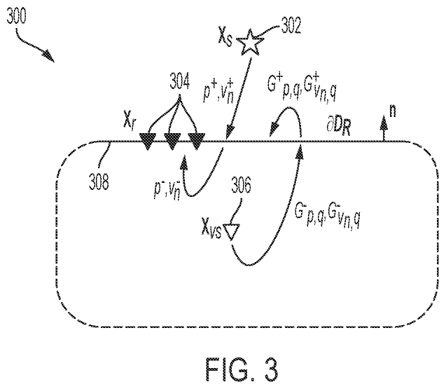

Recordings, using the tools described in FIGS. 1A-1C and FIG. 2, of waves propagating between xₛ and x_{νs} in the geometrical configuration shown in FIG. 3 can be constructed by cross-convolution via the following two-way integrals

$$p ( {x}_{vs} , {x}_{s} ω ) = {ϕ}_{\partial {D}_{R}} p ( {x}_{r} , {x}_{s} , ω ) {G}_{{v}_{n} , q} ( {x}_{r} , {x}_{vs} , ω ) - {v}_{n} ( {x}_{r} {x}_{s} , ω ) {G}_{p , q} ( {x}_{r} , {x}_{vs} , ω ) {dx}_{r} \qquad ( 1 )$$

$${v}_{i} ( {x}_{vs} , {x}_{s} ω ) = {ϕ}_{\partial {D}_{R}} p ( {x}_{r} , {x}_{s} , ω ) {G}_{{v}_{n} , {f}_{i}} ( {x}_{r} , {x}_{vs} , ω ) - {v}_{n} ( {x}_{r} {x}_{s} , ω ) {G}_{p , {f}_{i}} ( {x}_{r} , {x}_{vs} , ω ) {dx}_{r} \qquad ( 2 )$$

where for each angular frequency ω, ρ and νₙ represent the pressure and normal particle velocity recorded by receivers xᵣ at the boundary σD_{R} from a monopole source at xₛ. νₙ=ν·n where ν is the particle velocity vector and n is the outward pointing normal vector. G_{p,q} and G_{ν}_{ₙ}_{,q} denote the Green's functions from a monopole source (q) for pressure and normal velocity receivers, respectively, and in equation (1) these Green's functions are from a virtual source located at x_{νs}. Equation (2) may allow one to estimate pressure and normal particle velocity Green's functions from dipolar (spatial derivative) sources (ƒᵢ) at the virtual source location with i=x, y, z. If all fields can be assumed to be locally separated into down-going (+) and up-going (−) components at the boundary, then equation (1) and equation (2) can be recasted as

$${p}^{-} ( {x}_{vs} , {x}_{s} , ω ) = 2 {\int }_{\partial {D}_{R}} {p}^{+} ( {x}_{r} , {x}_{s} , ω ) {G}_{{v}_{n} , q}^{-} ( {x}_{r} , {x}_{vs} , ω ) {dx}_{r} \qquad ( 3 )$$

$${p}^{-} ( {x}_{vs} , {x}_{s} , ω ) = - 2 {\int }_{\partial {D}_{R}} {v}_{n}^{+} ( {x}_{r} , {x}_{s} , ω ) {G}_{p , q}^{-} ( {x}_{r} , {x}_{vs} , ω ) {dx}_{r} \qquad ( 4 )$$

$$and$$

$${v}_{i}^{-} ( {x}_{vs} , {x}_{s} , ω ) = 2 {\int }_{\partial {D}_{R}} {p}^{+} ( {x}_{r} , {x}_{s} , ω ) {G}_{{v}_{n} , {f}_{i}}^{-} ( {x}_{r} , {x}_{vs} , ω ) {dx}_{r} \qquad ( 5 )$$

$${v}_{i}^{-} ( {x}_{vs} , {x}_{s} , ω ) = - 2 {\int }_{\partial {D}_{R}} {v}_{n}^{+} ( {x}_{r} , {x}_{s} , ω ) {G}_{p , {f}_{i}}^{-} ( {x}_{r} , {x}_{vs} , ω ) {dx}_{r} \qquad ( 6 )$$

In some embodiments, the data collected from the various sources may include particle motion, acceleration, pressure, or velocity information of the waves.

One can solve the two-way or the one-way interferometry problem by inverting equations 1-2 or 3-6, respectively, for the unknown Green's functions. For the inversion of the equations above one may first discretize the integration along the receivers to a summation and then write the equations in matrix form for each angular frequency separately

$$U = DR \qquad ( 7 )$$

where D is a down-going data matrix with rows and columns corresponding to source locations xₛ and receiver locations xᵣ, respectively, that represents the wavefields that gets convolved with the Green's functions R in the equation above. Similarly, U is an up-going data matrix with rows and columns corresponding to source locations xₛ and virtual source locations x_{νs} that represents the wavefield recorded on the left-hand side of the equations. Finally, R is a matrix with rows and columns corresponding to receiver locations xᵣ and virtual source locations x_{νs} that represents the Green's functions. It is worth mentioning that in case of two-way interferometry, D is a data matrix composed of the concatenation of pressure and (negative) velocity data with rows and columns corresponding to source locations xₛ and receiver locations xᵣ, respectively. Also R is a matrix composed of the concatenation of velocity and pressure of the unknown Green's functions with rows and columns corresponding to receiver locations xᵣ and virtual source locations x_{νs}. Note that U and D can be any wavefield component that can be related through the integral equations similar to (3-7).

The inversion process of equation (7) is known as deconvolution where one may solve the following equation in the least-squares sense using the following:

$${min}_{R} \frac{1}{2} {‖ U - DR ‖}_{F}^{2} , \qquad ( 8 )$$

where U and D represent the monochromatic up- and down-going wavefields of size Nₛ×Nᵣ and Nₛ×Nᵣ, respectively. The Green's function R is of size Nᵣ×N_{νs}. Here, N_{νs} represents the locations of virtual sources datum at the receiver's location, and Nᵣ, Nₛ are the number of receivers and sources, respectively. Note that the reflectivity for each monochromatic wavefield may be solved independently. Also, equation (8) is only accurate to solve if the wavefields are sampled accurately enough along the receivers Nᵣ to do the correlation integrals free from aliasing related artifacts. For 3-dimensional (3D) seismic data acquisition, monochromatic U and D represents a 4-dimensional (4D) object where Nₛ=Nₛₓ×N_{sy}, and Nᵣ=Nᵣₓ×N_{ry}. Here, Nₛₓ, N_{sy} may represent the number of sources and Nᵣₓ, N_{ry} is number of receivers in x- and y-directions. One way of solving the above equation is by cross-correlating both sides in equation (8) by down-going wavefields. This may result in solving the following system of normal equation:

$${D}^{′} U = {D}^{′} DR \qquad ( 9 )$$

where ′ represents the conjugate-transpose. Here, C=D′U represents the monochromatic extended image volume restricted to the datum of interest, and Γ=D′D may be the point-spread function, which may be the radiation pattern of the virtual sources.

Under the assumption that the Earth subsurface represents horizontally layered medium and seismic data is acquired with shift-invariant parametrization of acquisition, the solution of equation (9) may be simplified when the up-going and down-going data is mapped into a multidimensional transform such as Fourier or Radon. Given this transformation, the up-going wavefield in equation (7) can be expressed as a convolution of the down-going wavefield with the earth's reflectivity for each plane-wave component. This is equivalent of performing a spectral division with a stabilization factor ε involving each plane-wave component at a time and expressed as:

$$r = ( {d}^{′} U ) ∅ ( {d}^{′} d + ε ) , \qquad ( 10 )$$

where Ø represents the Hadamard (element-wise) division, and the stabilization factor ε prevent noise in the solution resulting from the spectral notches present in the seismic data. Since deconvolution is being performed using element-wise spectral division, one may transfer from matrix-notation, i.e., R, U, D to vector-notation r, u, d in equation (10). Equation (10) is known as up-down deconvolution in seismic literature and the equivalent mathematical optimization problem is defined as

$${min}_{r} {‖ diag ( d ) r - u ‖}_{2}^{2} + ε {‖ I ‖}_{2}^{2}$$

where diag(d) returns a square diagonal matrix with the element of vector d on the main diagonal. Various theoretical and experimental results demonstrate that MDD gives excellent results on the condition that the seabed is relatively flat.

In particular, FIG. 3 shows the acquisition geometry 300 used in seismic interferometry by MDD. The star 302 denotes a source xₛ, triangles 304 are receivers xᵣ along the boundary σD_{R} and the triangle 306 refers to the receiver x_{νs} that seismic interferometry turns into a virtual source. The solid line 308 corresponds to the portion of the surface σD_{R} where data are assumed to be available. Rays denote the decomposition of the wavefields in terms of waves that are either ingoing (down, +) or outgoing (up, −) at the bary.

In some embodiments, data may be acquired in an acquisition environment having any acquisition design. In some embodiments, data may be acquired actually or virtually at any location in the earth interior.

However, for more complex geological settings, the equation (10) generate spurious location- and dip-dependent amplitude effects and a loss of frequency. This is because for more complex geological environments there are multiple scattering, incomplete illumination and the shadow zones, which further makes Γ=D′D ill-conditioned. To overcome these limitations, one may solve the up-down deconvolution problem in terms of interferometric redatuming using MDD. To solve this MDD problem, one may move away from the element-wise spectral division and instead perform the multidimensional inversion of the point-spread-function Γ, which results in the following damped least-squares expression

$$R = {( {D}^{′} D + λ I )}^{- 1} ( {D}^{′} U ) , \qquad ( 11 )$$

where (·)⁻¹ represents the matrix inverse. Although MDD stabilizes the estimation of the Green's function for complex geological scenarios, there are couple of caveats that remain. The first one is identifying the right regularization parameter, which requires human intervention. The second one is the damped least-squares system still results in loss in resolution (high frequency information) due to the dependency on the stabilization factor λ. To overcome this, it is beneficial to exploit additional constraints while performing MDD.

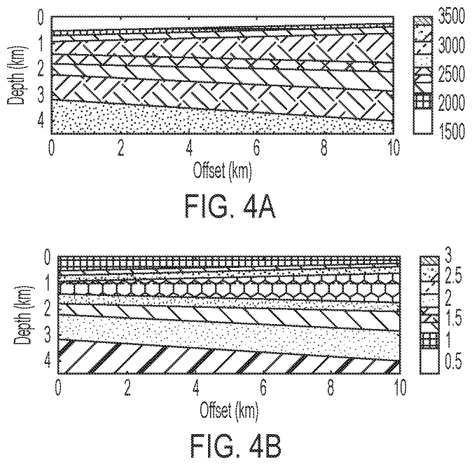

One such constraints is sparsity where the assumption is that the seismic data can be represented with very few coefficients in a transform domain, such as radon, curvelet, wavelet, or the like. Following this assumption, the least-squares system may be regularized by exploiting the sparsity of the seismic wavefields in the curvelet-domain. To illustrate the advantages of sparsity-promotion based MDD over the damped least-squares system, pressure and vertical velocity data are simulated on a carefully designed geologically complex model as shown in FIGS. 4A-4B.

To add additional complexity in the simulated wavefields, shallow scatterers may be added in the density model. Moreover, the layers are dipping between 1.6° (seabed) and 5° (deepest interface) along the x directions and are invariant in the y direction. The synthetic data is acquired with a split-spread acquisition geometry where sources and receivers are placed at 20 m periodically sampled grid, resulting in 451 shots and 401 receivers, respectively. The temporal sampling of the data is 4 ms.

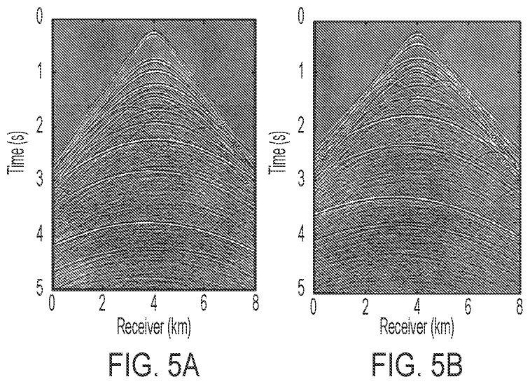

FIG. 5A shows the down-going component, and FIG. 5B shows the up-going component extracted from the pressure and vertical velocity components of FIG. 4B using the PZ summation, a common approach used in the seismic community.

Under the assumption that seismic data is sparser in nature in a transform domain, this MDD problem is cast as solving the following system of equations:

$$u = 𝒟 {AS}^{′} r \qquad ( 12 )$$

where r∈ [symbol] is an N_{c} dimensional coefficient vector of the unknown wavefield—that is, the Green's function may be restricted to the source-receiver array at a depth—in the sparse domain, S′∈ [symbol] is the sparsifying transform exploiting the sparsity of the Green's function with N=NₜNᵣ, Nₜ is the number of time samples, the vector u∈ [symbol] is the common receiver upgoing wavefield in the temporal frequency domain, the matrix [symbol] ∈ [symbol] is a block-diagonal downgoing wavefield in the temporal frequency domain for all the receivers Nᵣ where each sub-block corresponds to a monochromatic downgoing wavefield, and the temporal Fourier operator A∈ [symbol] maps the data from the time domain to the frequency domain. Note that the equation (12) may exploit the sparsity in the temporal-spatial domain without the need to form the normal equation as compared to the equation (9), which is solved monochromatically for the normal equation.

Therefore, the sparsity promoting MDD problem involves solving the following convex optimization problem (also known as the ‘Basis Pursuit Denoise’ (BPDN) problem)

$${min}_{r} {‖ r ‖}_{1} subject to \frac{1}{2} ‖ u - 𝒟 {FS}^{′} r {‖}_{2}^{2} \leq ϵ , {BPDN}_{ϵ} \qquad ( 13 )$$

where the [symbol] ₁ norm ∥r∥₁ is the sum of absolute values of the coefficients in the vector r, and ϵ is the noise level up to which to fit the least-squares misfit in equation (13). To solve the BPDN_{ϵ}, one may use a Linearized Bregman algorithm. The algorithm solves a slightly modified version of the BPDN_{ϵ} problem where an [symbol] ₂ penalty is added to the objective.

The combination of [symbol] ₁ and [symbol] ₂ penalty makes the objective function strongly convex. This small change in the objective function leads to a very simple couple of lines of iterative scheme for minimizing the BPDN_{ϵ} formulation. Moreover, the parameters λ controls the trade-off between the [symbol] ₁ and [symbol] ₂ norms of the unknown model vector. Also, choosing an appropriate value of λ in the linearized Bregman method is easily facilitated since the method does self-tuning of λ as the iteration progresses, i.e., a larger λ value prevents new entries to enter into the solution, but as the iteration progresses, more entries may start entering into the solution. Finally, Table (1) outlines an Algorithm 1 for the linearized Bregman framework for solving the MDD formulation.

Algorithm 1: Linearized Bregman framework to solve the sparse Multidimensional deconvolution problem

```
  Initialization r₁, z₁ = 0, λ, n
  Output r, the reflectivity after sparse inversion in the common receiver domain
```

| 1. | for i = 1, ... , n | |
|---|---|---|
| 2. | [symbol] = [symbol] (u − [symbol] FS’r) | “compute the residual” |
| 3. | g = ( [symbol] FS)’ [symbol] | “compute the gradient” |
| 4. | zᵢ₊₁ = zᵢ − tᵢg | “update the dual variable” |
| 5. | rᵢ₊₁ = [symbol] _{λ} (zᵢ₊₁) | “update the primal variable” |
| 6. | ${t}_{i} = \frac{‖ ‖}{‖ g ‖}$ | “dynamic step length computation” |
| 7. | end | |
| note: [symbol] _{λ}(z) = sign(z) · max(0, \|z\| − λ) | | “Soft-thresholding operation” |
| | $( x ) = max ( 0 , 1 - \frac{σ}{‖ x ‖} ) \cdot x$ | “projecting residual onto 2-norm ball constrained by σ” |

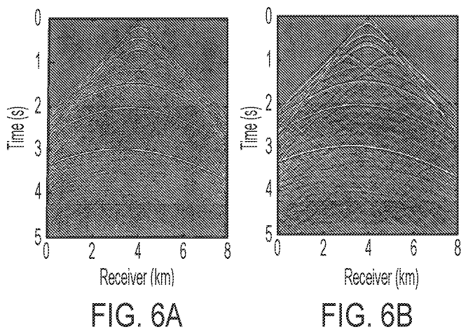

In Algorithm 1, λ is a user-defined parameter whose value corresponds to a certain percentage (e.g., 10%) of the maximum coefficient of the solution calculated at the first iteration for the least-squares migration. FIGS. 6A-6B illustrate the advantage of the sparsity-based optimization framework, as shown in FIG. 6B, over the damped least-squares solver for the MDD, as shown in FIG. 6A. In this example, one may exploit the sparsity using a 2D curvelet transform applied to a common-receiver gather, i.e., along the temporal-spatial axis. Although the damped least-squares inversion provides a numerically stable solution of the Green's function, the estimated Green's function is noisy irrespective of using the severe damping.

However, the results from the sparsity-based solver indicate the spatial and temporal bandwidths are well preserved and the estimated Green's function is relatively less noisy. The proposed sparsity-promoting approach, i.e., equation (14) produces numerically stable and artifact-free MDD results. The curvelet transform may be prohibitively expensive when applied to large-scale 3D and 5D seismic data volumes. This is because curvelet-based sparsity-promoting methods can become computationally intractable—in terms of speed and memory storage. Note that the 3D seismic data represents seismic data acquired in a 2D sail line, whereas 5D seismic data comes from 3D seismic acquisition where sources and receiver are spread along the x- and y-coordinates.

To mitigate the computational bottleneck of the curvelet based transform, rank-minimization techniques have shown the potential to overcome the computational bottleneck of exploiting the structure of large-scale seismic data in 3D and 5D. Hence, these methods are successfully used for seismic data pre-processing problems, such as interpolation and deblending. The main challenge in applying rank-minimization techniques to the seismic data interpolation problem is to find a “transform domain” wherein: i) fully sampled conventional (or unblended) seismic data have low-rank structure—i.e., quickly decaying singular values; and ii) subsampled seismic data have high-rank structure—i.e., slowly decaying singular values. When these properties hold, rank-minimization techniques (used in matrix completion) can be used to recover the deblended signal.

The frequency slices of fully sampled seismic data do not exhibit low-rank structure in the source-receiver (s−r) domain since strong wavefronts extend diagonally across the s−r plane. To overcome this, a rank-revealing transform domain is devised for 3D and 5D seismic data structures. For 3D seismic data where the data is organized in the time-source-receiver domain, transforming the data into the midpoint-offset (m−h) domain results in a vertical alignment of the wavefronts, thereby reducing the rank of the frequency slice matrix. Moreover, the sub-sampling does not noticeably change the decay of singular value in the (s−r) domain; but destroys the fast decay of singular values in the (m−h) domain, a feature for interpolation using rank minimization. In case of 5D seismic data, the underlying data is organized in time, source-x, source-y, receiver-x, receiver-y domain.

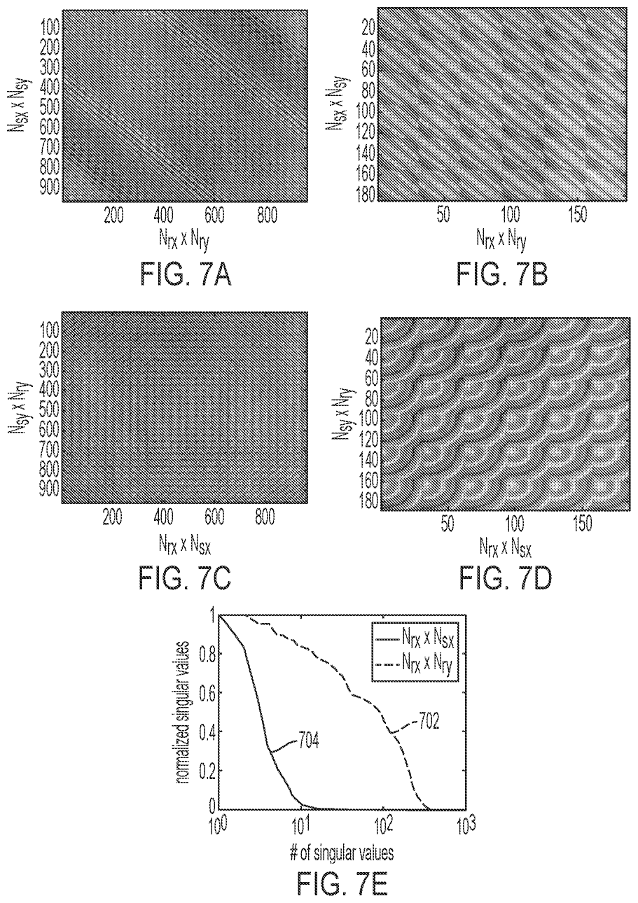

In this scenario, a temporal-Fourier transform is applied to extract the 4D wavefields in the frequency domain. The 4D tensor may be matricized into a 2D matrix. This is because the concept of singular value decomposition (SVD) is for matrices only. Here, matricization refers to unfolding a tensor into a matrix. For these 4D wavefields, the matricization strategy for grouping Nₛₓ×N_{sy}, i.e., may include placing both the source coordinates along the columns and receiver coordinates (Nᵣₓ×N_{ry}) along the rows, as shown in FIGS. 7A and 7B. This may result in a higher rank or slow decay of the singular values as shown in curve 702 of FIG. 7E. Note that the Nₛₓ×N_{sy} matricization results in a diagonal dominant matrix, as shown in FIGS. 7A and 7B, which causes the slow-decay of the singular values. However, grouping the Nₛₓ×Nᵣₓ along the columns and N_{sy}×N_{ry} along the rows, as shown in FIGS. 7C and 7D, may result in a matrix with fast decay of the singular values as shown in in curve 704 of FIG. 7E.

Following the same analogy, the low-rank structure of seismic data may be used in the transform domain for MDD. Note that for 3D deconvolution a midpoint-offset may be relied upon, whereas for 5D deconvolution one may rely on the matricization of a tensor as explained above. That is, let X be a matrix representation of the Green's function temporal-frequency domain. Under certain general conditions on the operator [symbol] , the solution to the rank minimization problem may be found by solving the following nuclear norm minimization problem:

$${min}_{X} {‖ X ‖}_{*} subject to \frac{1}{2} {‖ u - {𝒜}^{′} ( X ) ‖}_{2}^{2} \leq ϵ \qquad ( 15 )$$

where the operator [symbol] = [symbol] M [symbol] , and the operator [symbol] transform the monochromatic frequency slices from the physical domain to the rank-revealing transform domain. Here M is the sub-sampling operator, which can be manipulated to estimate the Green's function at a denser grid, if required, resulting in joint interpolation and deconvolution. In the 3D deconvolution scenario, the rank-revealing transform domain may require results in mapping from the source-receiver (s−r) domain to the midpoint-offset (m−h), and its adjoint does the opposite. The conversion from s−r) domain to (m−h) domain is a coordinate transformation, with the midpoint is defined by m=0.5(s+r) and the half-offset is defined by h=0.5(s−r). Note that, in mathematical terms, the transformation from (s−r) domain to (m−h) domain represents a tight frame. Here, the nuclear norm is defined as ∥X∥_{*}=∥σ∥₁ where σ is the vector of singular values. In order to efficiently solve equation (15), one may solve a sequence of LASSO subproblems:

$${min}_{X} \frac{1}{2} {‖ u - {𝒜}^{′} ( X ) ‖}_{2}^{2} subject to {‖ X ‖}_{*} \leq τ \qquad ( 16 )$$

where τ is updated by traversing the Pareto curve. Solving each LASSO subproblem requires a projection onto the nuclear norm ball ∥X∥_{*}≤τ in every iteration by performing a singular value decomposition and then thresholding the singular values. In the case of large-scale seismic problems, it becomes prohibitively expensive to carry out such many SVDs. Instead, a factorization-based approach may be used to the nuclear norm minimization.

The factorization approach parametrizes the matrix X∈ [symbol] as the product of two low rank factors L∈ [symbol] and R∈ [symbol] , such that X(i,:,:)=L(i,:,:)R(i,:,:)′, where index i runs over all the frequencies, and Nₖ is the rank of the underlying unknown. The optimization scheme can then be carried out using the factors L and R instead of X, thereby significantly reducing the size of the decision variable from N_{f}NₘNₕ to NₖN_{f}(Nₘ+Nₕ) when Nₖ≤(Nₘ, Nₕ). The nuclear norm may obey the relationship

$$X = {LR}^{′} \leq \frac{1}{2} {‖ [ \begin{matrix}L \\ R\end{matrix} ] ‖}_{F}^{2} = : φ ( L , R ) , \qquad ( 17 )$$

where ∥·∥_{F} is the Frobenius norm of the matrix (sum of the squared entries). Consequently, the LASSO subproblem can be replaced by

$${min}_{L , R} \frac{1}{2} {‖ u - {𝒜}^{′} ( {LR}^{′} ) ‖}_{2}^{2} subject to φ ( L , R ) \leq τ \qquad ( 18 )$$

where the projection onto φ(L, R)≤τ is easily achieved by multiplying each factor L and R by the scalar 2τ/φ(L, R). By equation (17), one may be guaranteed that LR′≤τ for any solution of equation (18).

To demonstrate the advantages of the proposed factorization-based rank-minimization framework over the curvelet domain sparsity-promotion, the MDD may be performed in a time-source-receiver domain using both sparsity-promotion and the rank-minimization framework. Apart from making sure that both the sparsity-promotion and the rank-minimization produces the same quality of the Green's function, the idea behind this approach is to demonstrate the computational and memory benefits of working with rank-minimization based solvers. To exploit the sparsity, the wavelet-curvelet domain may be used, where 1D wavelet is applied along the time domain and 2D curvelets are used along the source-receiver domain.

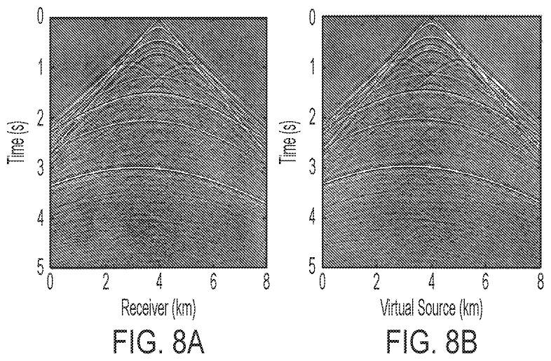

FIGS. 8A-8B shows the MDD results using the rank-minimization based approach extracted at a common virtual source (FIG. 8A) and a common receiver location (FIG. 8B). As one can see, the rank-minimization based approach can provide the noise-free estimation of the Green's function, while preserving the complex wavefield structure. Note that time gain (t¹) is applied for the visualization purposes. Moreover, the proposed rank-minimization based approach is 40 times faster than the sparsity-based approach in term of computational time. Also, for this small-scale example, a factor of 10 may be saved while storing the inverted Green's function in memory using the rank-minimization based approach as compared to the curvelet based approach. The benefit of rank-minimization based technique may be more pronounced when one switches from 3D to 5D multidimensional deconvolution where both the size of the sources and the receivers grow drastically.

Although, the rank-minimization-based methods can overcome the computational and memory bottleneck of MDD, a couple of issues remain while performing the MDD in real field seismic data scenarios. The first one is the instability of the deconvolution process at higher frequencies, which is because the subsampling of the data is not adequate to mitigate aliasing related artifacts. One way to overcome this is by interpolating the down- and up-going data at a finer grid but this can result in a memory bottleneck to store such dense data. Note that even adding a regularization such as sparsity and rank may not provide adequate stability to the aliasing-related artifacts while performing deconvolution.

The second issue is that while many seismic pre-processing workflows such as interpolation and deconvolution are performed monochromatically. Each frequency may be solved independently and in parallel. The similarities between the adjacent frequency slices may not be exploited explicitly. This, in turn, may create high-frequency noise artifacts when analyzing the estimated Green's function in the temporal-spatial domain. One may resolve this by working with multidimensional transform domains such as 3D and/or 5D Radon or Fourier domain to exploit the low-rank structure, however, this requires working with the complete temporal-spatial data in one setting, which is computationally infeasible in practice.

The third issue is that while the seismic data exhibit low-rank structure at the lower end of the spectrum, the same is not true at the higher frequencies where the low-rank assumption is not valid making rank-minimization based seismic pre-processing technology ineffective in situations where there may be interest in the broadband data. To overcome the aforementioned issues, priors may be derived based on the physics of propagation from the non-aliased low-frequency spectrum of the deconvoluted data to stabilize the deconvolution at higher frequencies. Apart from the physics-driven prior, lateral smoothness may be imposed along the spatial direction of the Green's function. The role of lateral smoothing makes sure that any high-wavenumber noise present in the estimated Green's function is subdued during the iterative process. Under the prior scheme, one may modify both the up-down deconvolution and multidimensional deconvolution framework.

For the up-down deconvolution scenario, the modified optimization framework is defined as:

$${min}_{r} {‖ diag ( d ) {Mw}^{′} Q Wr - u ‖}_{2}^{2} + ε {‖ I ‖}_{2}^{2} + λ {‖ Δ r ‖}_{2}^{2} , \qquad ( 19 )$$

where Q is defined as a prior matrix derived from the low-frequency spectrum and Δ represents the 5-point Laplacian operator to impose the lateral smoothness. Here W is a multi-dimensional windowing operator which divides data into small spatial windows along all the spatial dimensions, whereas its W′ performs partition of unity summation to patch all the spatial windows to get fully sampled monochromatic wavefield in the spatial domain. Thus, the modified normal-equation for up-down deconvolution is as follows:

$${d}^{′} u = ( {d}^{′} d + ε I + λ Δ ) Qr . \qquad ( 20 )$$

To solve equation (20) one may rely on an iterative solver such as LSQR. Similarly, under the prior operation, the following prior-driven rank-minimization formulation may be proposed for multidimensional deconvolution:

$${min}_{L , R} 0.5 ‖ {DMW}^{′} {QWNS}^{′} ( {LR}^{′} ) - u {‖}_{2}^{2} subject to 0.5 {‖ \begin{matrix}L \\ R\end{matrix} ‖}_{F}^{2} \leq τ \qquad ( 21 )$$

where N is a structural smoothing operator, i.e., a 5-point averaging operator to improve the lateral smoothness constraints.

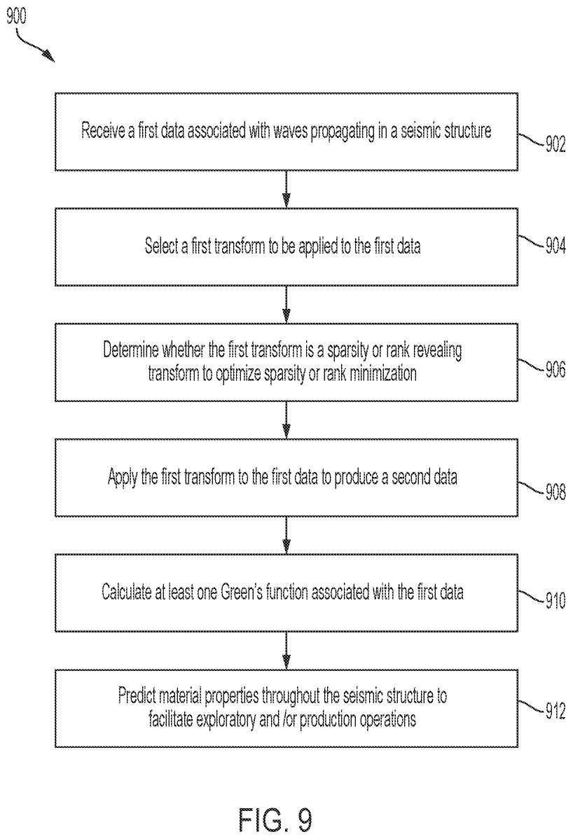

FIG. 9 is a workflow 900 illustrating a method for performing multidimensional deconvolution (MDD), in accordance with some embodiments. At block 902, the method includes receiving, using at least one processor, a first data associated with waves propagating in a seismic structure. At block 904, the method includes selecting, using the at least one processor, a first transform to be applied to the first data. At block 906, the method includes determining, using the least one processor, whether the first transform is a sparsity or rank revealing transform to optimize sparsity or rank minimization. If the first transform is the rank revealing transform, applying, using the at least one processor, the first transform to the first data to produce a second data, as shown in block 908. At block 910, the method includes calculating, using the at least one processor and the second data, at least one Green's function associated with the first data. At block 912, the method includes predicting, using the at least one processor and the at least one Green's function, material properties throughout the seismic structure to facilitate exploratory and/or production operations.

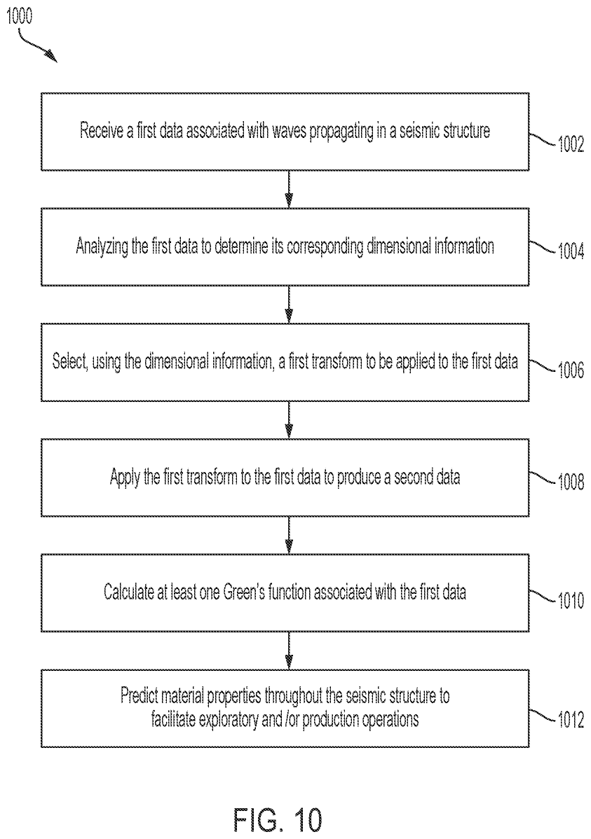

FIG. 10 is a workflow 1000 illustrating a method for performing multidimensional deconvolution (MDD), in accordance with some embodiments. At block 1002, the method includes receiving, using at least one processor, a first data associated with waves propagating in a seismic structure. At block 1004, the method includes analyzing, using the at least one processor, the first data to determine its corresponding dimensional information. At block 1006, the method includes selecting, using the at least one processor and the dimensional information, a first transform to be applied to the first data. The first transform includes a sparsity or rank revealing transform to optimize sparsity or rank minimization in accordance with the dimensional information of the first data. At block 1008, the method includes applying, using the at least one processor, the first transform to the first data to produce a second data. At block 1010, the method includes calculating, using the at least one processor and the second data, at least one Green's function associated with the first data. At block 1012, the method includes predicting, using the at least one processor and the at least one Green's function, material properties throughout the seismic structure to facilitate exploratory and/or production operations.

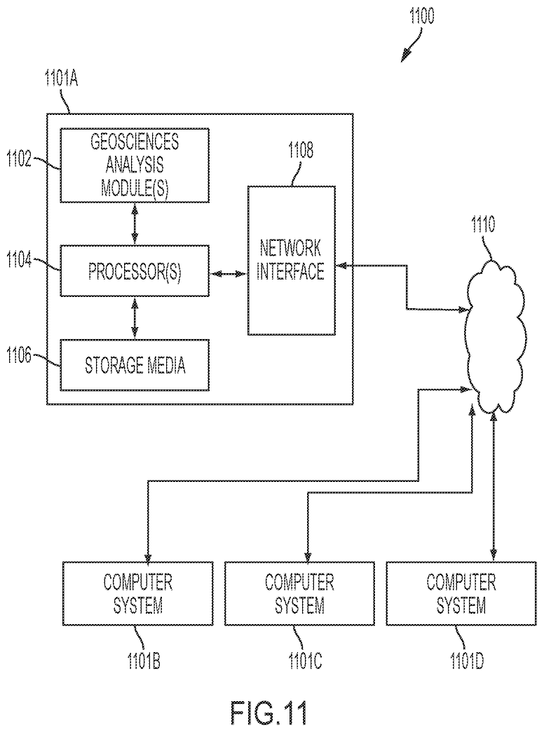

FIG. 11 depicts an example computing system 1100 in accordance with carrying out some of the methods of the present disclosure, in accordance with some embodiments. For example, the computing system 1100 may perform the workflows 900 and 1000 described herein.

The computing system 1100 can be an individual computer system 1101A or an arrangement of distributed computer systems. The computer system 1101A includes one or more geosciences analysis modules 1102 that are configured to perform various tasks according to some embodiments, such as one or more methods disclosed herein. To perform these various tasks, geosciences analysis module 1102 executes independently, or in coordination with, one or more processors 1104, which is (or are) connected to one or more storage media 1106. The processor(s) 1104 is (or are) also connected to a network interface 1108 to allow the computer system 1101A to communicate over a data network 1110 with one or more additional computer systems and/or computing systems, such as 1101B, 1101C, and/or 1101D (note that computer systems 1101B, 1101C and/or 1101D may or may not share the same architecture as computer system 1101A, and may be located in different physical locations, e.g., computer systems 1101A and 1101B may be on a ship underway on the ocean, while in communication with one or more computer systems such as 1101C and/or 1101D that are located in one or more data centers on shore, other ships, and/or located in varying countries on different continents). Note that data network 1110 may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device.

The storage media 1106 can be implemented as one or more computer-readable or machine-readable storage media. Note that while in the example embodiment of FIG. 11 storage media 1106 is depicted as within computer system 1101A, in some embodiments, storage media 1106 may be distributed within and/or across multiple internal and/or external enclosures of computing system 1101A and/or additional computing systems. Storage media 1106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that the instructions or methods discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions or located at a remote site from which machine-readable instructions can be downloaded over a network for execution.

It should be appreciated that computer system 1101A is one example of a computing system, and that computer system 1101A may have more or fewer components than shown, may combine additional components not depicted in the example embodiment of FIG. 11, and/or computer system 1101A may have a different configuration or arrangement of the components depicted in FIG. 11. The various components shown in FIG. 11 may be implemented in hardware, software, or a combination of both, hardware and software, including one or more signal processing and/or application specific integrated circuits.

It should also be appreciated that while no user input/output peripherals are illustrated with respect to computer systems 1101A, 1101B, 1101C, and 1101D, many embodiments of computing system 1100 include computing systems with keyboards, touch screens, displays, etc. Some computing systems in use in computing system 1100 may be desktop workstations, laptops, tablet computers, smartphones, server computers, etc.

Further, the steps in the processing methods described herein may be implemented by running one or more functional modules in an information processing apparatus such as general-purpose processors or application specific chips, such as ASICs, FPGAs, PLDs, or other appropriate devices. These modules, combinations of these modules, and/or their combination with general hardware are included within the scope of protection of the disclosure.

In some embodiments, a computing system is provided that comprises at least one processor, at least one memory, and one or more programs stored in the at least one memory, wherein the programs comprise instructions, which when executed by the at least one processor, are configured to perform any method disclosed herein.

In some embodiments, a computer readable storage medium is provided, which has stored therein one or more programs, the one or more programs comprising instructions, which when executed by a processor, cause the processor to perform any method disclosed herein.

In some embodiments, a computing system is provided that comprises at least one processor, at least one memory, and one or more programs stored in the at least one memory; and means for performing any method disclosed herein.

In some embodiments, an information processing apparatus for use in a computing system is provided, and that includes means for performing any method disclosed herein.

In some embodiments, a graphics processing unit is provided, and that includes means for performing any method disclosed herein.

Simulators may be used to run field development planning cases in the oil and gas industry. These involve running of thousands of such cases with slight variations in the model setup. Embodiments described herein can be applied readily to such applications and the resulting gains are significant.

The embodiments described herein can be used for stand-alone simulations or closed loop optimization routines and can be implemented as an on-premise standalone solution as well as a cloud solution.

While various embodiments in accordance with the disclosed principles have been described above, it should be understood that they have been presented by way of example only and are not limiting.

Furthermore, the above advantages and features are provided in described embodiments, but shall not limit the application of such issued claims to processes and structures accomplishing any or all of the above advantages.

1. A method, comprising:
receiving, using at least one processor, a first data associated with waves propagating in a seismic structure;
selecting, using the at least one processor, a first transform to be applied to the first data;
determining, using the least one processor, whether the first transform is a sparsity or rank revealing transform to optimize sparsity or rank minimization;
if the first transform is a sparsity or rank revealing transform, applying, using the at least one processor, the first transform to the first data to produce a second data;
calculating, using the at least one processor and the second data, at least one Green's function associated with the first data; and
predicting, using the at least one processor and the at least one Green's function, material properties throughout the seismic structure to facilitate exploratory and/or production operations.

2. The method of claim 1, wherein receiving the first data includes acquiring particle motion, acceleration, pressure, or velocity information of the waves.

3. The method of claim 1, wherein receiving the first data includes acquiring the first data in an acquisition environment with any acquisition design.

4. The method of claim 3, wherein receiving the first data includes acquiring the first data actually or virtually at any location in the earth interior.

5. The method of claim 1, wherein receiving the first data includes receiving data from at least one receiver or source.

6. The method of claim 5, wherein the at least one receiver comprises at least one virtual source.

7. The method of claim 1, wherein determining whether the first transform is the sparsity or rank revealing transform includes determining whether the first transform transforms the first data into a midpoint-offset (m−h) domain.

8. The method of claim 7, wherein determining whether the first transform is the sparsity or rank revealing transform includes determining whether the midpoint-offset (m−h) domain results in a vertical alignment of a plurality of wavefronts.

9. The method of claim 1, wherein determining whether the first transform is the sparsity or rank revealing transform includes applying physically driven priors to enhance low-rank or sparsity of the first data in a sparsity or rank revealing transform domain.

10. The method of claim 1, wherein the calculating the at least one Green's function includes calculating the at least one Green's function at a denser grid.

11. The method of claim 1, wherein determining whether the first transform is the rank revealing transform includes performing matricization of a tensor.

12. The method of claim 11, wherein performing matricization of the tensor includes determining whether the first data includes wavefield information used to develop the tensor.

13. A method, comprising:
receiving, using at least one processor, a first data associated with waves propagating in a seismic structure;
analyzing, using the at least one processor, the first data to determine its corresponding dimensional information;
selecting, using the at least one processor and the dimensional information, a first transform to be applied to the first data, wherein the first transform comprises a sparsity or rank revealing transform to optimize sparsity or rank minimization in accordance with the dimensional information of the first data;
applying, using the at least one processor, the first transform to the first data to produce a second data;
calculating, using the at least one processor and the second data, at least one Green's function associated with the first data; and
predicting, using the at least one processor and the at least one Green's function, material properties throughout the seismic structure to facilitate exploratory and/or production operations.

14. The method of claim 14, wherein selecting the first transform includes extracting four dimension or five dimension wavefield information from the first data.

15. A system for performing multidimensional deconvolution, the system comprising:
one or more computing device processors; and
one or more computing device memories, coupled to the one or more computing device processors, the one or more computing device memories storing instructions executed by the one or more computing device processors, wherein the instructions are configured to:
receive a first data associated with waves propagating in a seismic structure;
select a first transform to be applied to the first data;
determine whether the first transform is a sparsity or rank revealing transform to optimize sparsity or rank minimization;
if the first transform is the sparsity or rank revealing transform, apply the first transform to the first data to produce a second data; and
calculate, using the second data, at least one Green's function associated with the first data; and
predict, using the at least one Green's function, material properties throughout the seismic structure to facilitate exploratory and/or production operations.

16. The system of claim 15, wherein the first data comprises particle motion, acceleration, pressure, or velocity information of the waves.

17. The system of claim 15, wherein the first data is acquired in an acquisition environment with any acquisition design.

18. The system of claim 17, wherein the first data is acquired actually or virtually at any location in the earth interior.

19. The system of claim 15, wherein the first data comprises data from at least one receiver or source.

20. The system of claim 19, wherein the at least one receiver comprises at least one virtual source.

21. The system of claim 15, wherein the first transform transforms the first data into a midpoint-offset (m−h) domain.

22. The system of claim 21, wherein the midpoint-offset (m−h) domain results in a vertical alignment of a plurality of wavefronts.

23. The system of claim 15, wherein the first transform applies physically driven priors to enhance low-rank or sparsity of the first data in a sparsity or rank revealing transform domain.

24. The system of claim 15, wherein the first transform performs matricization of a tensor.

25. The system of claim 24, wherein the first data includes wavefield information used to develop the tensor.
